(19) United States
(12) Patent Application Publication
(10) Pub. No.: US 2023/0305840 A1
(43) Pub. Date: Sep. 28, 2023

(54) COMPUTING APPARATUS, INTEGRATED CIRCUIT CHIP, BOARD CARD, DEVICE AND COMPUTING METHOD

(71) Applicant: Cambricon (Xi'an) Semiconductor Co., Ltd., Xi'an (CN)

(72) Inventors: Jinhua TAO, Xi'an (CN); Xin YU, Xi'an (CN); Shaoli LIU, Xi'an (CN)

(21) Appl. No.: 18/003,687

(22) PCT Filed: May 18, 2021
(86) PCT No.: PCT/CN2021/094467

§ 371 Date: Jun. 8, 2023

(30) Foreign Application Priority Data
Jun. 29, 2020 (CN) 202010610807.2

(51) Int. Cl. G06F 9/30; G06F 7/544

(52) U.S. Cl. CPC G06F 9/30014; G06F 7/544

(57) ABSTRACT

The present disclosure discloses a computing apparatus, an integrated circuit chip, a board card, a device, and a method. The computing apparatus may be included in a combined processing apparatus. The combined processing apparatus may further include an interface apparatus and other processing apparatus. The computing apparatus interacts with other processing apparatus to jointly complete a computing operation specified by a user. The combined processing apparatus may further include a storage apparatus. The storage apparatus is connected to the computing apparatus and other processing apparatus, respectively. The storage apparatus is used to store data of the computing apparatus and other processing apparatus. A solution of the present disclosure may use at least two pieces of small bit width data representing large bit width data to perform operation processing, so that processing capacity of a processor is not influenced by a bit width of the processor.

### CROSS REFERENCE OF RELATED APPLICATION

The present application claims priority to Chinese Patent Application No. 2020106108072 with the title of “Computing Apparatus, Integrated Circuit Chip, Board Card, Device and Computing Method” filed on Jun. 29, 2020, the content of which is incorporated herein by reference in its entirety.

### TECHNICAL FIELD

The present disclosure generally relates to a data processing field. More specifically, the present disclosure relates to a computing apparatus, an integrated circuit chip, a board card, a device, and a computing method.

### BACKGROUND

At present, different types of processors may process different data bit widths. For a processor for performing a specific data type operation, a data bit width processed by the processor may often be limited. For example, a fixed-point operator may usually process a data bit width up to 16 bits, such as 16-bit integer data. However, in order to save computing costs and overheads and improve computing efficiency, how to make a processor with a limited bit width capable of processing data with more bit widths is a technical problem that is required to be solved.

### SUMMARY

In order to at least solve the technical problem mentioned above, the present disclosure, in many aspects, discloses a solution of using small bit width components (which are data with fewer bits) of large bit width data (which is data with more bits) to replace the large bit width data to perform computing. According to a computing solution of the present disclosure, at least two pieces of small bit width data may be used to represent the large bit width data and replace the large bit width data to perform operation processing. As such, in a scenario where a processing bit width of the processor is limited, the processor may still be used to complete computing of large bit width data.

A first aspect of the present disclosure provides a computing apparatus, including: an operation circuit configured to: receive a plurality of pieces of to-be-operated data associated with an operation instruction, where at least one piece of to-be-operated data is represented by two or more components, the at least one piece of to-be-operated data has a source data bit width, each component has a respective target data bit width, and the target data bit width is less than the source data bit width; and use these two or more components to replace the represented to-be-operated data to perform an operation specified by the operation instruction to obtain two or more intermediate results. The computing apparatus further includes: a combination circuit configured to combine the aforementioned intermediate results to obtain a final result; and a storage circuit configured to store the aforementioned intermediate results and/or the final result.

A second aspect of the present disclosure provides an integrated circuit chip, including the aforementioned computing apparatus of the first aspect.

A third aspect of the present disclosure provides an integrated circuit board card, including the aforementioned integrated circuit chip of the second aspect.

A fourth aspect of the present disclosure provides a computing device, including the aforementioned board card of the third aspect.

A fifth aspect of the present disclosure provides a method performed by a computing apparatus. The method includes: receiving a plurality of pieces of to-be-operated data associated with an operation instruction, where at least one piece of to-be-operated data is represented by two or more components, the at least one piece of to-be-operated data has a source data bit width, each component has a respective target data bit width, and the target data bit width is less than the source data bit width; using these two or more components to replace the represented to-be-operated data to perform an operation specified by the operation instruction to obtain two or more intermediate results; and combining the aforementioned intermediate results to obtain a final result.

Through the computing apparatus, the integrated circuit chip, the board card, the computing device, and the method described above, a solution of the present disclosure uses the small bit width components of the large bit width data to replace the large bit width data to perform computing. As such, in an artificial intelligence application scenario, such as a neural network operation, or other general scenarios, not limited by the processing bit width of the processor, computing power of the processor may be fully used. Further, for example, in a neural network operation scenario, the solution of the present disclosure may use at least two small bit width components to replace the large bit width data to perform computing, thereby simplifying neural network computing and improving computing efficiency.

### BRIEF DESCRIPTION OF DRAWINGS

By reading the following detailed description with reference to drawings, the above and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 is a simplified block diagram of a computing apparatus according to an embodiment of the present disclosure.

FIG. 2 is a detailed block diagram of a computing apparatus according to an embodiment of the present disclosure.

FIG. 3 is a detailed block diagram of a computing apparatus according to an embodiment of the present disclosure.

FIG. 4 is a detailed block diagram of a computing apparatus according to an embodiment of the present disclosure.

FIG. 5 is a detailed block diagram of a computing apparatus according to an embodiment of the present disclosure.

FIG. 6 is a flowchart of a computing method of a computing apparatus according to an embodiment of the present disclosure.

FIG. 7 is a structural diagram of a combined processing apparatus according to an embodiment of the present disclosure.

FIG. 8 is a schematic structural diagram of a board card according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the protection scope of the present disclosure.

It should be understood that terms such as “first”, “second”, and “third” appear in the claims, the specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

As mentioned earlier, in order to solve the problem that a processing bit width of a processor is limited, the present disclosure, in many aspects, discloses a solution of using small bit width components of large bit width data to replace the large bit width data to perform computing. Since at least two pieces of small bit width data are used to represent the large bit width data and replace the large bit width data to perform operation processing, operation results obtained by using the small bit width data are required to be combined to further obtain a final result. By using at least two pieces of small bit width (such as 16 bits and 8 bits) data (or called components) to represent the large bit width (such as 24 bits) data, the solution of the present disclosure may overcome a barrier of a limited bit width of the processor. Further, by using the small bit width data/components to replace the large bit width data to perform the operation, computing complexity may be simplified, and computing efficiency of, for example, neural network computing, may be improved. Furthermore, by splitting an operation of large bit width data into a plurality of operations of small bit width data, corresponding processing may be executed in parallel by processing circuits, which may further improve computing efficiency. The solution of the present disclosure is especially suitable for operation processing involving a multiplication operation, such as a multiplication or a multiplication and addition operation, where the multiplication and addition operation may include a convolution operation. Therefore, the solution of the present disclosure may be used to perform a neural network operation, especially to process weight data and neuron data, so as to obtain an expected operation result. For example, if a neural network is a convolution neural network for images, the weight data may be convolution kernel data, and the neuron data may be pixel data of an image or output data after a front layer operational operation.

Specific implementations of the present disclosure will be described in detail in combination with drawings below.

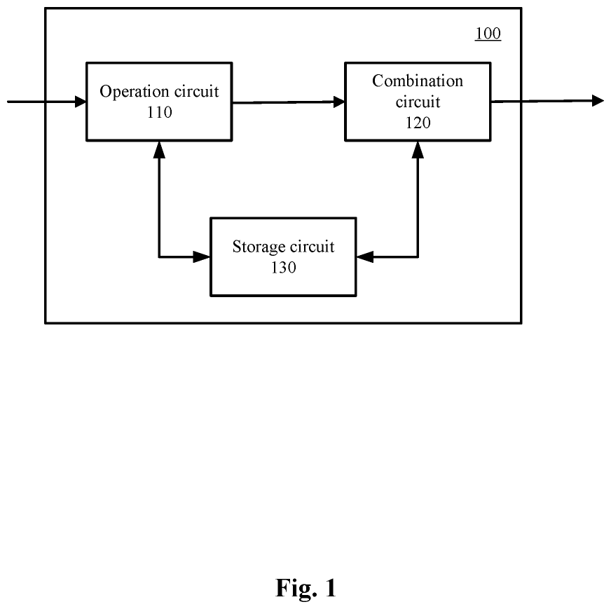

FIG. 1 is a simplified block diagram of a computing apparatus 100 according to an embodiment of the present disclosure. In one or more embodiments, the computing apparatus 100 may be used for operation processing of large bit width data to be applied to various application scenarios, such as an artificial intelligence application including a neural network operation or a general scenario where large bit width data is required to be split into small bit width data for computing.

As shown in FIG. 1, the computing apparatus 100 may include an operation circuit 110, a combination circuit 120, and a storage circuit 130.

In some embodiments, the operation circuit 110 may be configured to: receive a plurality of pieces of to-be-operated data associated with an operation instruction, where at least one piece of to-be-operated data is represented by two or more components. The at least one piece of to-be-operated data has a source data bit width, and each component has a respective target data bit width, where the target data bit width is less than the source data bit width.

As described earlier, a data bit width of to-be-operated data may exceed a processing bit width of the operation circuit. Based on this, to-be-operated data with a large bit width (the source data bit width) may be split into two or more components with a small bit width (the target data bit width) to be represented.

Splitting the to-be-operated data into the two or more components may be implemented based on various existing and/or future developed data splitting techniques.

In some embodiments, the number of components used for representing the to-be-operated data may be determined at least partly based on a source data bit width of the to-be-operated data and a data bit width supported by the operation circuit. In some other embodiments, the target data bit width may be determined at least partly based on the data bit width supported by the operation circuit. For example, if the data bit width of to-be-operated data is 24 bits, and the operation circuit supports a data bit width up to 16 bits, in an example, the to-be-operated data may be split into two components with different target data bit widths, including: an 8-bit high bit component and a 16-bit low bit component, or a 16-bit high bit component and an 8-bit low bit component. In another example, the to-be-operated data may be split into three components with same target data bit widths, including: an 8-bit high bit component, an 8-bit intermediate bit component, and an 8-bit low bit component. The present disclosure does not limit this aspect as long as a target data bit width of a component obtained after splitting satisfies a processing bit width limitation of the operation circuit.

The to-be-operated data may be split into a plurality of components according to the number of components required and a target data bit width of each component, where each component has a corresponding component value and a corresponding component scale factor. Taking splitting one piece of large bit width data into two pieces of small bit width components as an example, the following describes a possible data splitting method briefly, but those skilled in the art may understand that the present disclosure does not limit this aspect.

In an example, the large bit width data may be split into two components: a first component and a second component. The first component may be a high bit component or a low bit component; accordingly, the second component may be the low bit component or the high bit component.

First, based on the target data bit width of each component and/or a bit position of each component in data (the large bit width data) before splitting, a component scale factor of each component may be determined. For example, when a target data bit width of the first component (the high bit component in this example) is n1, and a target data bit width of the second component (the low bit component in this example) is n2, if no sign bit is included in the n2, a component scale factor of the first component may be 2n2-1. In contrast, if there is a sign bit included in the n2, the component scale factor of the first component may be 2n2. Generally, a component scale factor of the low bit component defaults to 1.

Next, by using the component scale factor of the first component, to-be-split large bit width data may be computed to obtain a component value of the first component. The first component may be represented by the component value and the corresponding component scale factor.

Then, by computing according to the to-be-split large bit width data and the component value of the first component obtained above, a component value of the second component may be obtained. In an example, if no sign bit is included in a data bit width of the second component, for example, if the highest bit of the data bit width of the second component is not the sign bit, by subtracting the first component from the to-be-split large bit width data, a value of the second component may be obtained. Here, the first component is a multiplication product of the component value of the first component and the corresponding component scale factor of the first component.

By using the method above, the large bit width data may be split into two components, and each component has the corresponding component value and the corresponding component scale factor. If data is required to be split into more than two components, the method above may be executed iteratively until components of a required quantity are obtained. For example, for data with a 24-bit data bit width, if the data is determined to be split into three components and all the three components are components with 8-bit data bit widths, through the aforementioned steps, the data with the 24-bit data bit width may be split into a first component with an 8-bit data bit width and an intermediate second component with a 16-bit data bit width first. Next, for the intermediate second component with the 16-bit data bit width, the aforementioned steps may be executed repeatedly, so as to further split the component into a second component with an 8-bit data bit width and a third component with an 8-bit data bit width.

Those skilled in the art may understand that various processing may be adopted to optimize the data splitting method. The present disclosure does not limit this aspect as long as a component after splitting may be received for a specified operation.

Going back to FIG. 1, in some embodiments, the operation circuit 110 may be further configured to use these two or more components to replace the represented to-be-operated data to perform an operation specified by an operation instruction to obtain two or more intermediate results.

Specifically, the operation circuit 110 may be configured to use two or more components of one piece of to-be-operated data to perform the specified operation with corresponding data of other to-be-operated data respectively, and output corresponding operation results to the combination circuit 120.

Depending on a specific operation instruction, other to-be-operated data may include one or a plurality of pieces of to-be-operated data. Each piece of to-be-operated data may have a different data bit width. If the data bit width of to-be-operated data satisfies the processing bit width limit of the operation circuit, splitting may be not required, and original data may be used to perform the operation. In another aspect, although some pieces of to-be-operated data are split into a plurality of components, in some cases, only a certain component or some components are required to perform the operation. Therefore, in this case, the corresponding data of other to-be-operated data may include any one of the followings: original data of the to-be-operated data, or at least one component representing the to-be-operated data.

The operation circuit 110 may use received data to perform the operation specified by the operation instruction to further obtain two or more intermediate results, and output the intermediate results to the combination circuit 120. Those skilled in the art may understand that the operation circuit 110 may perform the specified operation according to an order of receiving these two or more components to further obtain each intermediate result sequentially and output each intermediate result to the combination circuit 120. The order of these components may include: an order from a high bit to a low bit, or an order from the low bit to the high bit.

In some embodiments, the combination circuit 120 may be configured to: combine the intermediate results input from the operation circuit 110 to obtain a final result. As described earlier, since at least one piece of to-be-operated data uses its two or more components to perform the operation, a result obtained by using each component to perform the operation is an intermediate result, and the intermediate results are required to be combined to obtain the final result.

In some embodiments, the combination circuit 120 may be further configured to perform weighted combining on the operation results serving as the intermediate results to obtain the final result. Since a component used to replace original to-be-operated data to perform the operation has the corresponding component value and the corresponding component scale factor, and during the operation, the operation circuit 110 may only use the component value to perform the operation to obtain the intermediate result, in the combination circuit 120, the component scale factor of the component participating in the operation may be used to perform the weighted combining of the intermediate results. The following will detail various implementations of the combination circuit based on several embodiments.

The computing apparatus 100 may further include a storage circuit 130 configured to store the aforementioned intermediate results and/or the final result. As described earlier, since results obtained by performing the operation by using the component by the operation circuit 110 is the intermediate results, these intermediate results are required to be combined. During the combining, according to the generation of the intermediate results, loop combining may be performed, such as weighted accumulation. Therefore, the storage circuit may be used to store these intermediate results temporarily or permanently. Preferably, in some embodiments, the intermediate results and the final result may share a storage space of the storage circuit to further save the storage space. Those skilled in the art may understand that the storage circuit 130 may be used to store other data and information, such as intermediate data required to be stored that is obtained during an operation period of the operation circuit 110. The present disclosure does not limit this aspect.

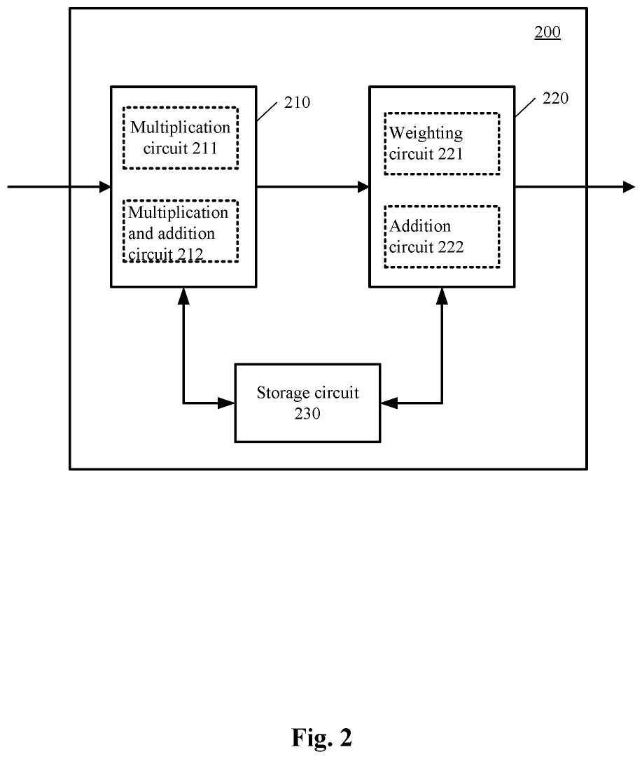

FIG. 2 is a detailed block diagram of a computing apparatus 200 according to an embodiment of the present disclosure. As described earlier, a solution of the present disclosure is especially suitable for operation processing involving a multiplication operation. Therefore, in this embodiment, an operation circuit 210 of the computing apparatus 200 may be specifically implemented as a multiplication circuit 211 or a multiplication and addition circuit 212. The multiplication and addition circuit 212 may be configured to, for example, implement a convolution operation.

Since a component that replaces original to-be-operated data to perform an operation has a corresponding component value and a corresponding component scale factor, and the component scale factor is associated with a bit position of the component in the represented to-be-operated data, when a multiplication-like operation is involved, such as a multiplication operation or a multiplication and addition operation, the multiplication circuit 211 or the multiplication and addition circuit 212, during the operation, may only use the component value to perform the operation to obtain an operation result as an intermediate result. The influence of the component scale factor may be processed later through a combination circuit 220.

As shown in FIG. 2, the combination circuit 220 may include a weighting circuit 221 and an addition circuit 222. The weighting circuit 221 may be configured to use a weighting factor to perform weighting processing on a current operation result of the operation circuit 210, such as a product result of the multiplication circuit 211 or a multiplication and addition result of the multiplication and addition circuit 212, or a previous combination result of the combination circuit 220. Depending to different weighted objects, the weighting factor may be different. In some embodiments, the weighting factor may be determined at least partly based on a component scale factor of a component that generates a corresponding operation result. The addition circuit 222 may be configured to accumulate a weighted result and other intermediate results to obtain a final result.

For different weighted objects, the following respectively describes possible implementations of the weighting circuit 221 in the combination circuit 220 of FIG. 2.

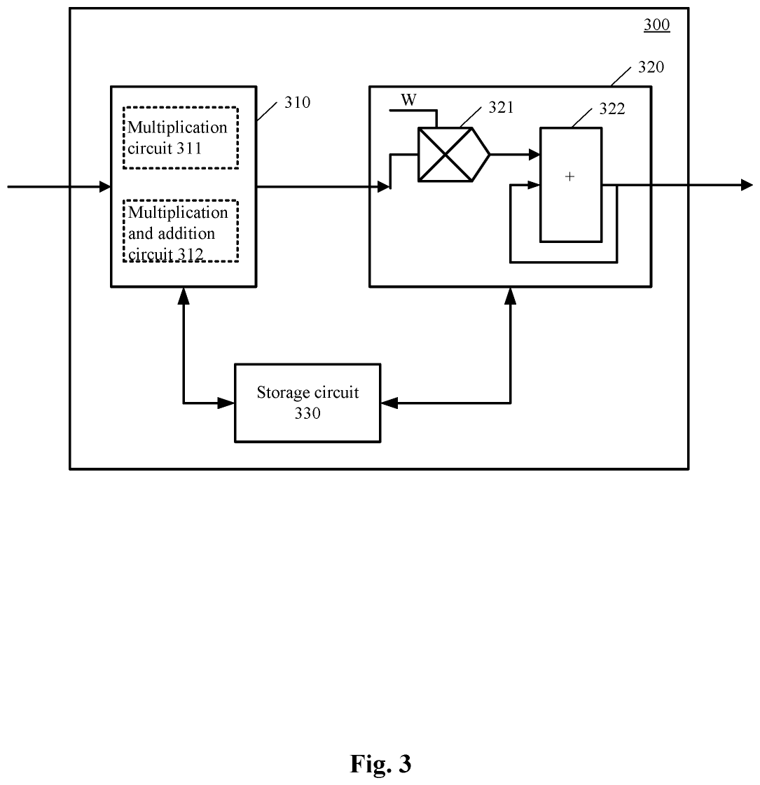

FIG. 3 is a detailed block diagram of a computing apparatus 300 according to an embodiment of the present disclosure. In this embodiment, one kind of implementation of the weighting circuit 221 of FIG. 2 is further shown. In this implementation, a weighted object is a current operation result of the operation circuit 210.

As shown in FIG. 3, a weighting circuit 321 may be configured to multiply an operation result of an operation circuit 310 by a first weighting factor to obtain a weighted result. If an operation of the operation circuit 310 is a multiplication operation or a multiplication and addition operation, the first weighting factor may be a product of component scale factors of components corresponding to the operation result. Those skilled in the art may understand that for different operation results, the first weighting factor may be different. At this time, an addition circuit 322 may be configured to accumulate an obtained weighted result and a previous addition result of the addition circuit 322.

Taking an operation of two pieces of data as an example, the following further describes a specific implementation of the embodiment shown in FIG. 3.

In an example, it is supposed that an operation instruction specifies performing a multiplication operation on large bit width data A and data B. Both the data A and the data B have been split into two components in advanced. For example, the data A and the data B may be respectively represented as:

A=a1*scaleA1+a0*scaleA0;

B=b1*scaleB1+b0*scaleB0.

In the expressions above, a1 and a0 are component values of a high bit component and a low bit component of the data A respectively; and scaleA1 and scaleA0 are corresponding component scale factors respectively. Similarly, b1 and b0 are component values of a high bit component and a low bit component of the data B respectively; and scaleB1 and scaleB0 are corresponding component scale factors respectively. In this example, if components are used to replace the data A and the data B to perform the multiplication operation, four times of multiplication operations are required to be performed. No matter these four times of multiplication operations are performed in which order, it is only required to adjust the weighting factor accordingly to obtain a final operation result.

For example, the aforementioned multiplication operation may be represented as:

$$\begin{matrix}A * B = ( a 1 * scaleA 1 + a 0 * scaleA 0 ) * ( b 1 * scaleB 1 + b 0 * scaleB 0 ) \\ = ( a 1 * b 1 ) * ( scaleA 1 * scaleB 1 ) + ( a 1 * b 0 ) * ( scaleA 1 * scaleB 0 ) + \\ ( a 0 * b 1 ) * ( scaleA 0 * scaleB 1 ) + ( a 0 * b 0 ) * ( scaleA 0 * scaleB 0 )\end{matrix} .$$

From the expression above, the operation circuit 310 may perform a multiplication operation between each component value, which may be a1*b1, a1*b0, a0*b1 and a0*b0 in this example. Additionally, in this example, first weighting factors corresponding to the aforementioned four intermediate results may be scaleA1*scaleB1, scaleA1*scaleB0, scaleA0*scaleB1, and scaleA0*scaleB0 respectively. The weighting circuit 321 may use the corresponding first weighting factors to weight the aforementioned intermediate results respectively. The addition circuit 322 may sum weighted intermediate results to obtain a final result.

In some embodiments, values of some component scale factors may be 1. For example, a value of scaleA0 or scaleB0 may be 1. At this time, when the first weighting factor is computed, a corresponding multiplication may be omitted. For example, computing of scaleA1*scaleB0, scaleA0*scaleB1 and scaleA0*scaleB0 may be omitted.

In another example, it is supposed that the operation instruction specifies performing a convolution operation on large bit width data A and data B, where the data A may be a neuron in a neural network operation, and the data B may be a weight in the neural network operation. Both the data A and the data B have been split into two components in advanced. For example, the data A and the data B may be respectively represented as:

A=a1*scaleA1+a0*scaleA0;

B=b1*scaleB1+b0*scaleB0.

In the expressions above, a1 and a0 are component values of a high bit component and a low bit component of the data A respectively; and scaleA1 and scaleA0 are corresponding component scale factors respectively. Similarly, b1 and b0 are component values of a high bit component and a low bit component of the data B respectively; and scaleB1 and scaleB0 are corresponding component scale factors respectively. In this example, if components are used to replace the data A and the data B to perform the convolution operation, four times of convolution operations are required to be performed. No matter these four times of convolution operations are performed in which order, it is only required to adjust the weighting factor accordingly to obtain a final operation result.

In an example, an operation process is shown in an order of the low bit first and the high bit later:

a0(conv)b0−>tmp0,tmp0*W00−>p0;

a1(conv)b0−>tmp1,tmp1*W10+p0−>p1;

a0(conv)b1−>tmp2,tmp2*W01+p1−>p2;

a1(conv)b1−>tmp3,tmp3*W11+p2−>p3;

In the expressions above, conv represents the convolution operation; tmp0, tmp1, tmp2 and tmp3 are convolution results of the four times of convolution operations respectively; W00, W10, W01 and W11 are corresponding weighting factors respectively; and p0, p1, p2 and p3 are combination results after weighted combining. It may be understood that p0 is a first combination result, and since there is no previous combination data, p0 may directly correspond to a weighted result.

In another example, the operation process is shown in an order of the high bit first and the low bit later:

a1(conv)b1−>tmp3,tmp3*W11−>p3;

a0(conv)b1−>tmp2,tmp2*W01+p3−>p2;

a1(conv)b0−>tmp1,tmp1*W10+p2−>p1;

a0(conv)b0−>tmp0,tmp0*W00+p1−>p0;

In the expressions above, a meaning of each sign is the same as the above. It may be understood that p3 is a first combination result, and since there is no previous combination data, p3 may directly correspond to a weighted result.

In the two examples above, the weighting factor may be a product of component scale factors of components corresponding to a convolution result. For example,

W00=scaleA0*scaleB0;

W10/scaleA1*scaleB0;

W01/scaleA0*scaleB1;

W11=scaleA1*scaleB1.

Similarly, in some embodiments, the values of some component scale factors may be 1. For example, the value of scaleA0 or scaleB0 may be 1. At this time, when the first weighting factor is computed, the corresponding multiplication may be omitted. For example, computing of W00, W10 and W01 may be omitted, thereby improving computing efficiency.

In the two examples above, any one of the data A and the data B or both the data A and the data B may be a scalar or a vector. If the data is the vector, each element of the vector may be split into two or more components to replace these elements to perform the operation. Since each element of the vector may not affect each other, an operation involving each element may be processed in parallel, thereby improving operation efficiency.

Additionally, from the operation processes above, it may be shown that no matter the operation of each component is performed in which order, since the first weighting factor directly corresponds to a product of component scale factors of components corresponding to each intermediate result/operation result, the weighted results may be accumulated directly to obtain the final result. An implementation of FIG. 3 is not limited by an operation order of the operation circuit 310 and/or an inputting order of the intermediate results.

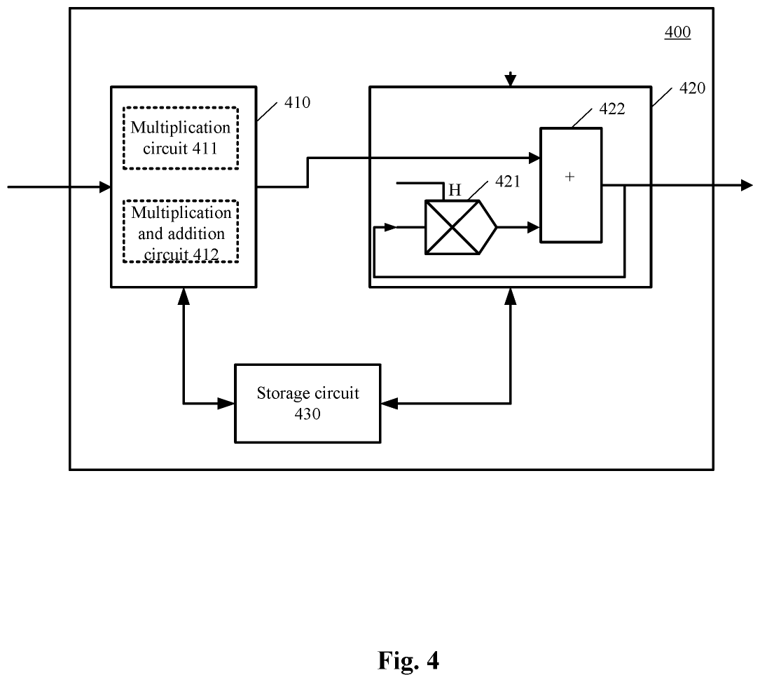

FIG. 4 shows another kind of implementation of the weighting circuit 221 of FIG. 2. In this implementation, an operation order of a high bit first and a low bit later is optimized. In this situation, a weighted object of a weighting circuit is a previous operation result of a combination circuit.

As shown in FIG. 4, a weighting circuit 421 may be configured to multiply a previous addition result of an addition circuit 422 by a second weighting factor to obtain a weighted result. At this time, the second weighting factor is a ratio of a scale factor of a previous operation result of an operation circuit 410 to a scale factor of a current operation result of an operation circuit 410, where the scale factor of the operation result is determined according to component scale factors of components corresponding to the operation result. Those skilled in the art may understand that for each combination, the second weighting factor may be different. At this time, the addition circuit 422 may be configured to accumulate a weighted result of the weighting circuit 421 and the current operation result of the operation circuit 410.

Similarly, taking the convolution operation of data A and data B described earlier as an example, a specific implementation of the embodiment shown in FIG. 4 will be further described.

According to the operation order of the high bit first and the low bit later, an operation process is shown as follows:

a1(conv)b1−>tmp3,tmp3−>p3;

a0(conv)b1−>tmp2,tmp2+p3*H33−>p2;

a1(conv)b0−>tmp1,tmp1+p2*H22−>p1;

a0(conv)b0−>tmp0,tmp0+p1*H11−>p0;

p0=p0*H00.

In the operation process above, a meaning of each sign is the same as the above, and H00, H11, H22 and H33 are corresponding weighting factors respectively. In this example, the weighting factors may be determined as follows:

H33=(scaleA1*scaleB1)/(scaleA0*scaleB1);

H22=(scaleA0*scaleB1)/(scaleA1*scaleB0);

H11=(scaleA1*scaleB0)/(scaleA0*scaleB0);

H00=scaleA0*scaleB0.

From the operation process above, it may be shown that a combination result is required to be weighted again finally, and a weighing factor H00 corresponds to a scale factor of a final operation result tmp0. At this time, the operation of the operation circuit 410 for the operation instruction is completed, and there is no operation result. In order to unify computing of the weighting factors, the scale factor of the current operation result may be set as 1, and thereby, a weighting factor for a final weighting still corresponds to the ratio of the scale factor of the previous operation result to the scale factor of the current operation result.

Similarly, in some embodiments, values of some component scale factors may be 1. For example, a value of scaleA0 or scaleB0 may be 1. At this time, when the second weighting factor is computed, a corresponding multiplication may be omitted. For example, computing of scaleA1*scaleB0, scaleA0*scaleB1 and scaleA0*scaleB0 may be omitted. Simultaneously, a final weighting of the combination result may also be omitted, which means that p0=p0*H00 may be omitted, thereby improving computing efficiency.

From the operation process above, it may be shown that since an operation result of a component value of a high bit component is incrementally increased through multiple times of weightings, when two numbers used for addition differ greatly, for example, a very large number is added to a very small number, a phenomenon of loss of precision due to connecting steps may be avoided.

In some embodiments, if the operation instruction is a multiplication operation instruction or a multiplication and addition operation instruction, any one of data that performs the operation is 0, a result must be 0. At this time, the data such as 0 may not be required to perform computing, and accordingly, a current operation circuit may be closed and may not perform the operation and may directly output the result, thereby saving operation power consumption and saving computing resources and/or storage resources.

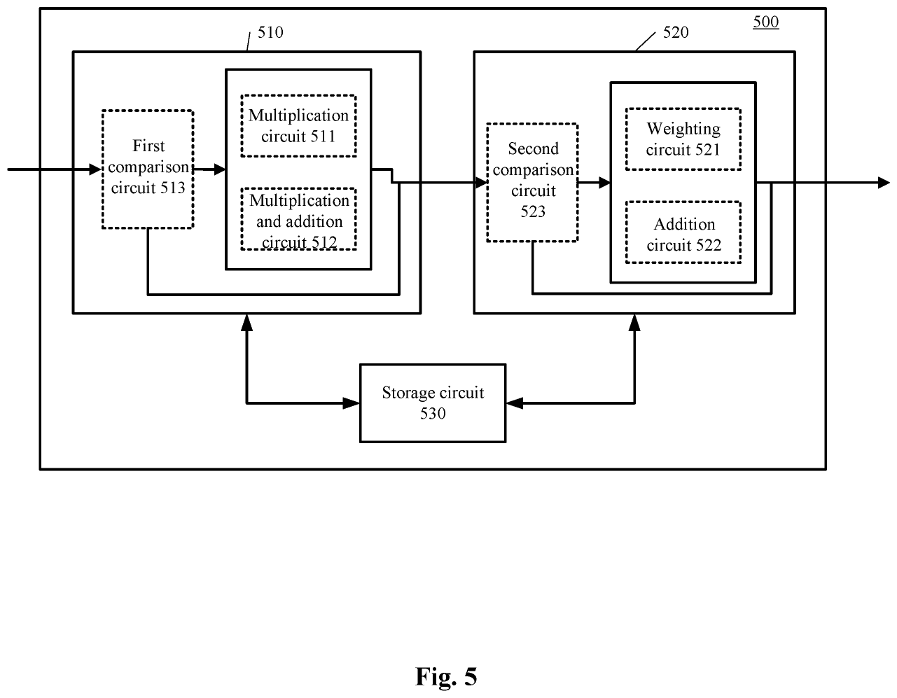

FIG. 5 is a detailed block diagram of a computing apparatus 500 according to an embodiment of the present disclosure. In this embodiment, a first comparison circuit 513 is added in an operation circuit 510. The first comparison circuit 513 may be configured to judge whether any one of data that is to be used to perform a specified operation in this circuit is 0. It may be understood that the data may include any one of followings: original data of to-be-operated data, or a component representing the to-be-operated data. If the data is 0, performing the specified operation on the data may be omitted, and the operation may be directly skipped to an operation on a next piece of data. Otherwise, the specified operation continues to be perform by using this piece of data as described earlier.

Alternatively or additionally, a second comparison circuit 523 may be set in a combination circuit 520. The second comparison circuit 523 may be configured to: judge whether a received intermediate result is 0; if the intermediate result is 0, combination processing on the intermediate result may be omitted; otherwise, this intermediate result is continued to be used to perform the combination processing as described earlier. Similarly, this kind of processing method may save operation power consumption and save computing resources and/or storage resources.

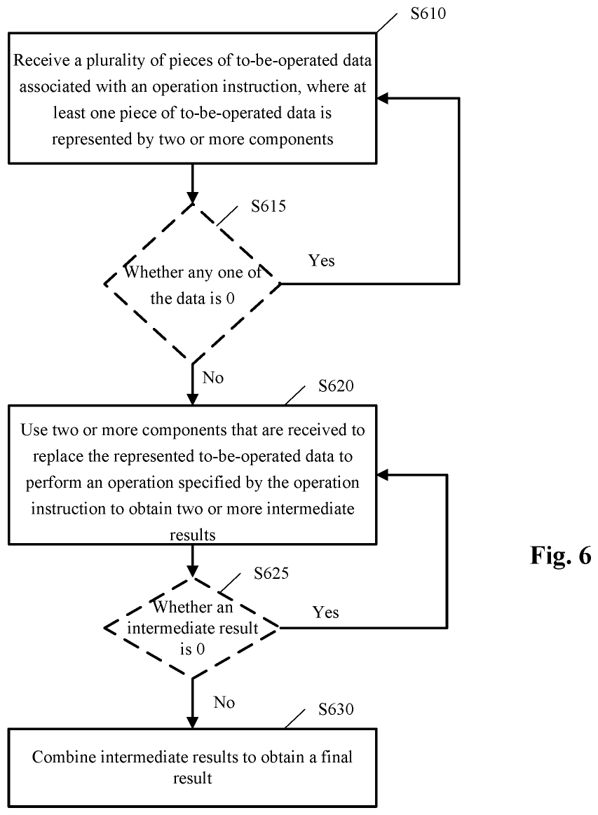

FIG. 6 is a flowchart of a computing method 600 performed by a computing apparatus according to an embodiment of the present disclosure. As described above, in one or more embodiments, the computing method 600 may be used for operation processing of large bit width data to be applied to various application scenarios, such as an artificial intelligence application including a neural network operation, or a general scenario, where the large bit width data is required to be split into small bit width data for computing.

As shown in FIG. 6, in a step S610, a plurality of pieces of to-be-operated data associated with an operation instruction are received, where at least one piece of to-be-operated data is represented by two or more components. The at least one piece of to-be-operated data has a source data bit width, each component has a respective target data bit width, and the target data bit width is less than the source data bit width.

Optionally, in some embodiments, if the operation instruction involves a multiplication operation or a multiplication and addition operation (such as a convolution operation), the method 600 may further include a step S615. In the step S615, for example, through the first comparison circuit 513 in FIG. 5, whether any one of data that is to be used to perform an operation in the circuit is 0 is judged. The data may include any one of followings: original data of the to-be-operated data, or a component representing the to-be-operated data.

If the data is not 0, the method 600 proceeds to a step S620. In the step S620, two or more components that are received are used to replace the represented to-be-operated data to perform an operation specified by the operation instruction to obtain two or more intermediate results.

If any one of the data is 0, the method 600 skips the step S620, which means that the data is not used to perform the operation specified by the operation instruction, and the method 600 directly continues to a next operation. Because when the operation is a multiplication operation or a multiplication and addition operation, a 0 on either side of the operation will result in a 0 result, the specified operation may be omitted on the data with a value of 0, thereby saving computing resources and reducing power consumption.

Going back to the step S620, performing the specified operation may include: using the two or more components of the one piece of to-be-operated data to perform the specified operation with corresponding data of other to-be-operated data respectively to obtain corresponding operation results. As mentioned earlier, other to-be-operated data may include one or a plurality of pieces of to-be-operated data. Moreover, the corresponding data of other to-be-operated data may include any one of followings: the original data of the to-be-operated data, or at least one component representing the to-be-operated data.

Optionally, in some embodiments, the method 600 may further include a step S625. In the step S625, for example, through the second comparison circuit 523 in FIG. 5, whether an intermediate result that is to be used to perform combination processing in the circuit is 0 is judged. If the intermediate result is 0, the method 600 skips a step S630, which means that the intermediate result is not used to perform the combination processing, and the method 600 directly continues to perform a next combination of intermediate results, thereby saving computing resources and reducing power consumption.

Finally, in the step S630, the intermediate results that are obtained in the step S620 may be combined to obtain a final result. In some embodiments, combining the intermediate results may include: performing weighted combining on the operation results output in the step S620 to obtain the final result.

The computing method 600 of the embodiment of the present disclosure is especially suitable for operation processing involving the multiplication operation, such as the multiplication or the multiplication and addition operation, where the multiplication and addition operation may include a convolution operation. Since a component that replaces original to-be-operated data to perform the operation has a corresponding component value and a corresponding component scale factor, and the component scale factor is associated with a bit position of the component in the represented to-be-operated data, when a multiplication-like operation is involved, such as the multiplication operation or the multiplication and addition operation, only the component value may be used to perform the operation to obtain the operation results as the intermediate results. The influence of the component scale factor may be processed during result combining later.

For example, in some embodiments, in the step S620, performing the specified operation may include: using the component value to perform the operation to obtain the operation results. Further, in the step S630, performing the weighted combining may include: using a weighting factor to perform weighted combining of a current operation result and a previous combination result, where the weighting factor is determined at least partly based on a component scale factor of a component corresponding to the current operation result.

As mentioned earlier, based on an operation order of the component, such as an order from a low bit to a high bit, or an order from the high bit to the low bit, different weighted combining ways may be used.

In some embodiments, in the step S630, performing the weighted combining may include: multiplying the operation result of the step S620 by a first weighting factor to obtain a weighted result, where the first weighting factor is a product of component scale factors of components corresponding to the current operation result; and accumulating the weighted result and the previous combination result.

In some other embodiments, in the step S630, performing the weighted combining may include: multiplying the previous combination result by a second weighting factor to obtain the weighted result, where the second weighting factor is a ratio of a scale factor of a previous operation result to a scale factor of the current operation result, where the scale factor of the operation result is determined according to the component scale factors of the components corresponding to the operation result; and accumulating the weighted result and the current operation result of the step S620.

Referring to the flowchart, the above has described the computing method performed by the computing apparatus of the embodiment of the present disclosure. Those skilled in the art may understand that, since an operation of large bit width data is split into a plurality of operations of small bit width data, corresponding processing of each step of the method above may be executed in parallel, thereby further improving computing efficiency.

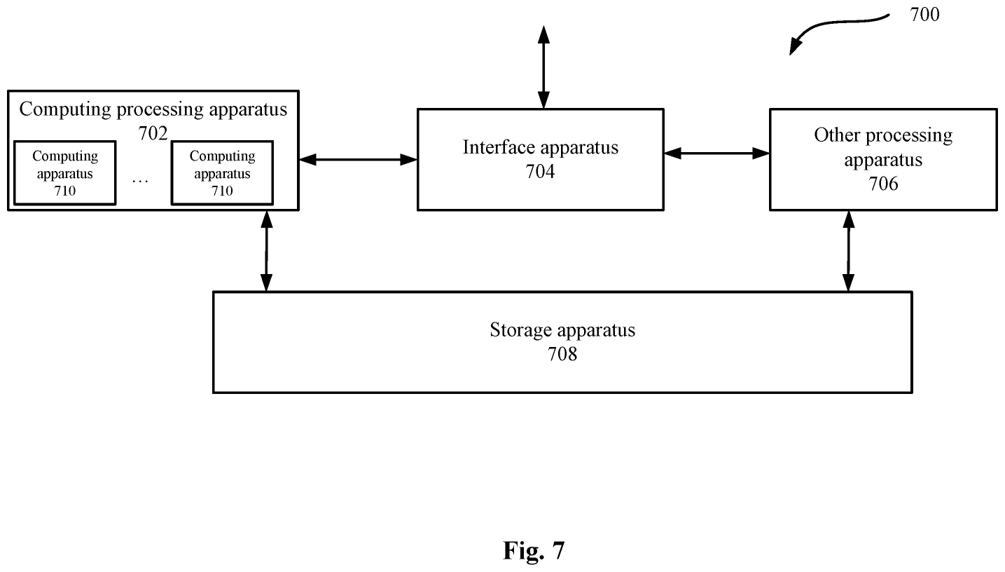

FIG. 7 is a structural diagram of a combined processing apparatus 700 according to an embodiment of the present disclosure. As shown in FIG. 7, the combined processing apparatus 700 may include a computing processing apparatus 702, an interface apparatus 704, other processing apparatus 706, and a storage apparatus 708. According to different application scenarios, the computing processing apparatus may include one or a plurality of computing apparatuses 710, and the computing apparatus may be configured to perform an operation described above in combination with FIGS. 1-6.

In different embodiments, the computing processing apparatus of the present disclosure may be configured to perform an operation specified by a user. In an exemplary application, the computing processing apparatus may be implemented as a single-core artificial intelligence processor or a multi-core artificial intelligence processor. Similarly, one or a plurality of computing apparatuses included in the computing processing apparatus may be implemented as an artificial intelligence processor core or a partial hardware structure of the artificial intelligence processor core. If the plurality of computing apparatuses are implemented as artificial intelligence processor cores or partial hardware structures of the artificial intelligence processor cores, the computing processing apparatus of the present disclosure may be regarded as having a single-core structure or an isomorphic multi-core structure.

In an exemplary operation, the computing processing apparatus of the present disclosure interacts with other processing apparatus through the interface apparatus to jointly complete the operation specified by the user. According to different implementations, other processing apparatus of the present disclosure may include one or more kinds of general-purpose and/or special-purpose processors, including a central processing unit (CPU), a graphics processing unit (GPU), an artificial intelligence processor, and the like. These processors may include but are not limited to a digital signal processor (DSP), an application specific integrated circuit (ASIC), a field-programmable gate array (FPGA), or other programmable logic devices, discrete gate or transistor logic devices, discrete hardware components, and the like. The number of the processors may be determined according to actual requirements. As described above, the computing processing apparatus of the present disclosure may be regarded as having the single-core structure or the isomorphic multi-core structure. However, when considered together, both the computing processing apparatus and other processing apparatus may be regarded as forming a heterogeneous multi-core structure.

In one or more embodiments, other processing apparatus may serve as an interface that connects the computing processing apparatus (which may be embodied as an artificial intelligence computing apparatus such as a computing apparatus for a neural network operation) of the present disclosure to external data and control. Other processing apparatus may perform basic controls that include but are not limited to moving data, starting and/or stopping the computing apparatus. In another embodiment, other processing apparatus may also cooperate with the computing processing apparatus to jointly complete an operational task.

In one or more embodiments, the interface apparatus may be used to transfer data and a control instruction between the computing processing apparatus and other processing apparatus. For example, the computing processing apparatus may obtain input data from other processing apparatus via the interface apparatus and write the input data to an on-chip storage apparatus of the computing processing apparatus (or called a memory). Further, the computing processing apparatus may obtain the control instruction from other processing apparatus via the interface apparatus and write the control instruction to an on-chip control caching unit of the computing processing apparatus. Alternatively or optionally, the interface apparatus may further read data in the storage apparatus of the computing processing apparatus and then transfer the data to other processing apparatus.

Additionally or optionally, the combined processing apparatus of the present disclosure may further include a storage apparatus. As shown in figure, the storage apparatus may be connected to the computing processing apparatus and other processing apparatus respectively. In one or more embodiments, the storage apparatus may be used to store data of the computing processing apparatus and/or other processing apparatus. For example, the data may be data that may not be fully stored inside the computing processing apparatus or other processing apparatus, or in the on-chip storage apparatus of the computing processing apparatus or other processing apparatus.

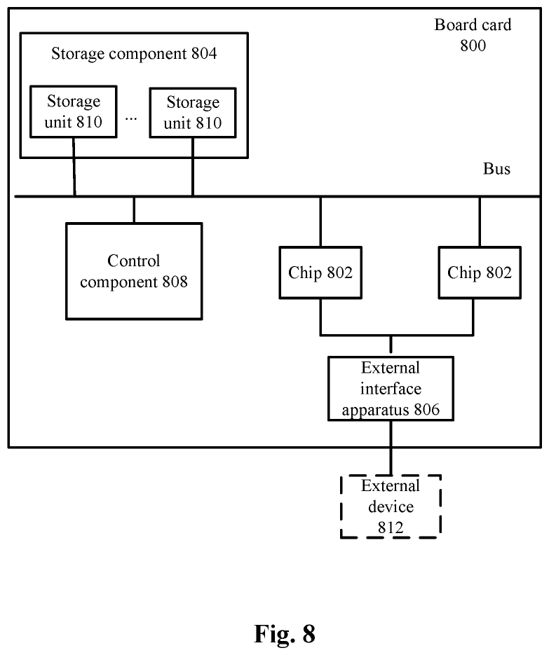

In some embodiments, the present disclosure also provides a chip (such as a chip 802 shown in FIG. 8). In an implementation, the chip may be a system on chip (SoC) and may integrate one or a plurality of combined processing apparatuses shown in FIG. 7. The chip may be connected to other related components through an external interface apparatus (such as an external interface apparatus 806 shown in FIG. 8). The related components may be a camera, a monitor, a mouse, a keyboard, a network card, or a WIFI interface. In some application scenarios, the chip may integrate other processing units (such as a video codec) and/or an interface unit (such as a dynamic random access memory (DRAM) interface), and the like. In some embodiments, the present disclosure provides a chip package structure, including the chip above. In some embodiments, the present disclosure provides a board card, including the chip package structure above. The following will describe the board card in detailed in combination with FIG. 8.

FIG. 8 is a schematic structural diagram of a board card 800 according to an embodiment of the present disclosure. As shown in FIG. 8, the board card may include a storage component 804 for storing data, which may include one or a plurality of storage units 810. The storage component may connect and transfer data to a control component 808 and the aforementioned chip 802 through a bus. Further, the board card may include an external interface apparatus 806, which may be configured to implement data relay or transfer between the chip (or the chip in the chip package structure) and an external device 812 (such as a server or a computer, and the like). For example, to-be-processed data may be transferred from the external device to the chip through the external interface apparatus. For another example, a computing result of the chip may be still sent back to the external device through the external interface apparatus. According to different application scenarios, the external interface apparatus may have different interface forms. For example, the external interface apparatus may be a standard peripheral component interconnect express (PCIe) interface.

In one or more embodiments, the control component in the board card of the present disclosure may be configured to regulate and control a state of the chip. As such, in an application scenario, the control component may include a micro controller unit (MCU), which may be used to regulate and control a working state of the chip.

According to the aforementioned descriptions in combination with FIG. 7 and FIG. 8, those skilled in the art may understand that the present disclosure also provides an electronic device or apparatus, which may include one or a plurality of the aforementioned board cards, one or a plurality of the aforementioned chips, and/or one or a plurality of the aforementioned combined processing apparatuses.

According to different application scenarios, the electronic device or apparatus may include a server, a cloud server, a server cluster, a data processing device, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical and other fields. Further, the electronic device or apparatus of the present disclosure may be used in application scenarios including cloud, edge, and terminal related to artificial intelligence, big data, and/or cloud computing. In one or more embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or more embodiments, hardware information of the cloud device is compatible with that of the terminal device and/or the edge device. As such, according to hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for a part that is not described in detail in a certain embodiment of the present disclosure, reference may be made to related descriptions in other embodiments.

For a specific implementation, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering a logical function, but there may be other division methods during actual implementations. For another example, a plurality of units or components may be combined or integrated into another system, or some features or functions in the units or components may be selectively disable. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in a same position or distributed to a plurality of network units. Additionally, according to actual requirements, some or all of the units may be selected for achieving the purpose of the solution described in embodiments of the present disclosure. Additionally, in some scenarios, a plurality of units in the embodiments of the present disclosure may be integrated into one unit, or each of the units may be physically separated.

In some implementation scenarios, the aforementioned integrated unit may be implemented in the form of a software program module. If the integrated unit is implemented in the form of the software program module and sold or used as an independent product, the integrated unit may be stored in a computer-readable memory. Based on such understanding, if the solution of the present disclosure may be embodied in the form of a software product (such as a computer-readable storage medium), the software product may be stored in a memory, and the software product may include several instructions used to enable a computer device (which may be a personal computer, a server, or a network device, and the like) to perform part or all of steps of the method of the embodiments of the present disclosure. The foregoing memory may include but is not limited to an USB, a flash disk, a read only memory (ROM), a random access memory (RAM), a mobile hard disk, a magnetic disk, or an optical disc, and other media that may store a program code.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a central processing unit (CPU), a graphics processing unit (GPU), a field-programmable gate array (FPGA), a digital signal processor (DSP), and an application-specific integrated circuit (ASIC). Further, the aforementioned storage unit or storage apparatus may be any appropriate storage medium (including a magnetic storage medium or a magneto-optical storage medium, and the like), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), ROM, and RAM, and the like.

Although a plurality of embodiments of the present disclosure have been shown and described, it is obvious to those skilled in the art that such embodiments are provided only as examples. Those skilled in the art may think of many methods to modify, alter, and substitute without deviating from the thought and spirit of the present disclosure. It should be understood that alternatives to the embodiments described herein may be employed in the practice of the present disclosure. The attached claims are intended to limit the scope of protection afforded by the present disclosure and therefore to cover equivalents or alternatives within the scope of these claims.

The foregoing may be better understood according to following articles:

Article 1. A computing apparatus, including:
an operation circuit configured to:
receive a plurality of pieces of to-be-operated data associated with an operation instruction, where at least one piece of to-be-operated data is represented by two or more components, where the at least one piece of to-be-operated data has a source data bit width, and each of the components has a respective target data bit width, where the target data bit width is less than the source data bit width; and
use the two or more components to replace the represented to-be-operated data to perform an operation specified by the operation instruction to obtain two or more intermediate results;
a combination circuit configured to:
combine the intermediate results to obtain a final result; and
a storage circuit configured to store the intermediate results and/or the final result.

Article 2. The computing apparatus of article 1, where
the operation circuit is configured to use the two or more components of the one piece of to-be-operated data to perform the operation with corresponding data of other to-be-operated data respectively, and output corresponding operation results to the combination circuit; and
the combination circuit is configured to perform weighted combining on the operation results to obtain the final result.

Article 3. The computing apparatus of article 2, where other to-be-operated data includes one or a plurality of pieces of to-be-operated data, and the corresponding data of other to-be-operated data includes any one of followings: original data of the to-be-operated data, or at least one component representing the to-be-operated data.

Article 4. The computing apparatus of any one of articles 2-3, where the operation instruction includes an instruction involving a multiplication operation or a multiplication and addition operation, and the operation circuit includes a multiplication operation circuit or a multiplication and addition operation circuit.

Article 5. The computing apparatus of article 4, where each of the components has a component value and a component scale factor, and the component scale factor is associated with a bit position of a corresponding component in the represented to-be-operated data, where the operation circuit is configured to use the component value to perform the operation to obtain the operation results; and the combination circuit is configured to use a weighting factor to perform weighted combining on a current operation result of the operation circuit and a previous combination result of the combination circuit, where the weighting factor is determined at least partly based on a component scale factor of a component corresponding to the operation result.

Article 6. The computing apparatus of article 5, where the combination circuit includes a weighting circuit and an addition circuit;
the weighting circuit is configured to multiply the operation result of the operation circuit by a first weighting factor to obtain a weighted result, where the first weighting factor is a product of component scale factors of components corresponding to the operation result; and
the addition circuit is configured to accumulate the weighted result and a previous addition result of the addition circuit.

Article 7. The computing apparatus of article 5, where the combination circuit includes a weighting circuit and an addition circuit;
the weighting circuit is configured to multiply a previous addition result of the addition circuit by a second weighting factor to obtain a weighted result, where the second weighting factor is a ratio of a scale factor of a previous operation result of the operation circuit to a scale factor of the current operation result of the operation circuit, where the scale factor of the operation result is determined according to the component scale factor of the component corresponding to the operation result; and
the addition circuit is configured to accumulate the weighted result and the current operation result of the operation circuit.

Article 8. The computing apparatus of any one of articles 4-6, where the operation circuit further includes a first comparison circuit configured to:
judge whether any one of data that is to be used to perform the operation in the circuit is 0, where the data includes any one of followings: the original data of the to-be-operated data, or the component representing the to-be-operated data; and
omit performing the operation specified by the operation instruction on the data if the data is 0;
otherwise, use the data to perform the operation specified by the operation instruction.

Article 9. The computing apparatus of any one of articles 1-8, where the combination circuit further includes a second comparison circuit configured to:
judge whether a received intermediate result is 0; and
omit performing the combining on the intermediate result if the intermediate result is 0;
otherwise, use the intermediate result to perform the combining.

Article 10. The computing apparatus of any one of articles 1-9, where
the number of components used for representing the at least one piece of to-be-operated data is determined at least partly based on the source data bit width and a data bit width supported by the operation circuit; and/or
the target data bit width is determined at least partly based on the data bit width supported by the operation circuit.

Article 11. The computing apparatus of any one of articles 1-10, where
the operation circuit is further configured to perform the operation specified by the operation instruction according to an order of receiving the two or more components, where the order includes: an order from a high bit to a low bit, or an order from the low bit to the high bit.

Article 12. The computing apparatus of any one of articles 1-11, where the to-be-operated data is a vector, and performing the operation specified by the operation instruction includes:
performing the operation between elements in the vector in parallel.

Article 13. An integrated circuit chip, including the computing apparatus of any one of articles 1-12.

Article 14. An integrated circuit board card, including the integrated circuit chip of article 13.

Article 15. A computing device, including the board card of article 14.

Article 16. A method performed by a computing apparatus, including:
receiving a plurality of pieces of to-be-operated data associated with an operation instruction, where at least one piece of to-be-operated data is represented by two or more components, where the at least one piece of to-be-operated data has a source data bit width, and each of the components has a respective target data bit width, where the target data bit width is less than the source data bit width;
using the two or more components to replace the represented to-be-operated data to perform an operation specified by the operation instruction to obtain two or more intermediate results; and
combining the intermediate results to obtain a final result.

Article 17. The method of article 16, where
performing the operation specified by the operation instruction includes:
using the two or more components of the one piece of to-be-operated data to perform the operation with corresponding data of other to-be-operated data respectively to obtain
corresponding operation results; and
combining the intermediate results includes:
performing weighted combining on the operation results to obtain the final result.

Article 18. The method of article 17, where the operation instruction includes an instruction involving a multiplication operation or a multiplication and addition operation.

Article 19. The method of article 18, where each of the components has a component value and a component scale factor, and the component scale factor is associated with a bit position of a corresponding component in the represented to-be-operated data;
performing the operation specified by the operation instruction includes:
using the component value to perform the operation to obtain the operation results; and
performing the weighted combining includes:
using a weighting factor to perform weighted combining on a current operation result and a previous combination result, where the weighting factor is determined at least partly based on a component scale factor of a component corresponding to the operation result.

Article 20. The method of article 19, where performing the weighted combining includes:
multiplying the operation result by a first weighting factor to obtain a weighted result, where the first weighting factor is a product of component scale factors of components corresponding to the operation result; and
accumulating the weighted result and the previous combination result.

Article 21. The method of article 19, where performing the weighted combining includes:
multiplying the previous combination result by a second weighting factor to obtain a weighted result, where the second weighting factor is a ratio of a scale factor of a previous operation result to a scale factor of the current operation result, where the scale factor of the operation result is determined according to the component scale factor of the component corresponding to the operation result; and
accumulating the weighted result and the current operation result.

Article 22. The method of any one of articles 16-21, further including:
judging whether any one of data that is to be used to perform the operation is 0, where the data includes any one of followings: original data of the to-be-operated data, or a component representing the to-be-operated data; and
not using the component to perform the operation specified by the operation instruction if the component is 0;
omitting performing the operation specified by the operation instruction on the data if the data is 0;
otherwise, using the data to perform the operation specified by the operation instruction.

The embodiments of the present disclosure have been described in detail above. Specific examples have been used in the specification to explain principles and implementations of the present disclosure. The descriptions of the embodiments above are only used to facilitate understanding of the method and core ideas of the present disclosure. Simultaneously, those skilled in the art may change or transform the specific implementation and application scope of the present disclosure according to the ideas of the present disclosure. The changes and transformations shall all fall within the protection scope of the present disclosure. In summary, the content of this specification should not be construed as a limitation on the present disclosure.

What is claimed:

1. A computing apparatus, comprising:
an operation circuit configured to:
receive a plurality of pieces of to-be-operated data associated with an operation instruction, wherein at least one piece of to-be-operated data is represented by two or more components, wherein the at least one piece of to-be-operated data has a source data bit width, and each of the components has a respective target data bit width, wherein the target data bit width is less than the source data bit width; and
use the two or more components to replace the represented to-be-operated data to perform an operation specified by the operation instruction to obtain two or more intermediate results;
a combination circuit configured to:
combine the intermediate results to obtain a final result; and
a storage circuit configured to store the intermediate results and/or the final result.

2. The computing apparatus of claim 1, wherein
the operation circuit is configured to use the two or more components of the one piece of to-be-operated data to perform the operation with corresponding data of other to-be-operated data respectively, and output corresponding operation results to the combination circuit; and
the combination circuit is configured to perform weighted combining on the operation results to obtain the final result.

3. The computing apparatus of claim 2, wherein other to-be-operated data comprises one or a plurality of pieces of to-be-operated data, and the corresponding data of other to-be-operated data comprises any one of followings: original data of the to-be-operated data, or at least one component representing the to-be-operated data.

4. The computing apparatus of claim 2, wherein the operation instruction comprises an instruction involving a multiplication operation or a multiplication and addition operation, and the operation circuit comprises a multiplication operation circuit or a multiplication and addition operation circuit.

5. The computing apparatus of claim 4, wherein each of the components has a component value and a component scale factor, and the component scale factor is associated with a bit position of a corresponding component in the represented to-be-operated data, wherein
the operation circuit is configured to use the component value to perform the operation to obtain the operation results; and
the combination circuit is configured to use a weighting factor to perform weighted combining on a current operation result of the operation circuit and a previous combination result of the combination circuit, wherein the weighting factor is determined at least partly based on a component scale factor of a component corresponding to the operation result.

6. The computing apparatus of claim 5, wherein the combination circuit comprises a weighting circuit and an addition circuit;
the weighting circuit is configured to multiply the operation result of the operation circuit by a first weighting factor to obtain a weighted result, wherein the first weighting factor is a product of component scale factors of components corresponding to the operation result; and
the addition circuit is configured to accumulate the weighted result and a previous addition result of the addition circuit.

7. The computing apparatus of claim 5, wherein the combination circuit comprises a weighting circuit and an addition circuit;
the weighting circuit is configured to multiply a previous addition result of the addition circuit by a second weighting factor to obtain a weighted result, wherein the second weighting factor is a ratio of a scale factor of a previous operation result of the operation circuit to a scale factor of the current operation result of the operation circuit, wherein the scale factor of the operation result is determined according to the component scale factor of the component corresponding to the operation result; and
the addition circuit is configured to accumulate the weighted result and the current operation result of the operation circuit.

8. The computing apparatus of claim 4, wherein the operation circuit further comprises a first comparison circuit configured to:
judge whether any one of data that is to be used to perform the operation is 0, wherein the data comprises any one of followings: the original data of the to-be-operated data, or the component representing the to-be-operated data; and
omit performing the operation specified by the operation instruction on the data if the data is 0;
otherwise, use the data to perform the operation specified by the operation instruction.

9. The computing apparatus of claim 1, wherein the combination circuit further comprises a second comparison circuit configured to:
judge whether a received intermediate result is 0; and
omit performing the combining on the intermediate result if the intermediate result is 0;
otherwise, use the intermediate result to perform the combining.

10. The computing apparatus of claim 1, wherein
the number of components used for representing the at least one piece of to-be-operated data is determined at least partly based on the source data bit width and a data bit width supported by the operation circuit; and/or
the target data bit width is determined at least partly based on the data bit width supported by the operation circuit.

11. The computing apparatus of claim 1, wherein the operation circuit is further configured to perform the operation specified by the operation instruction according to an order of receiving the two or more components, wherein the order comprises: an order from a high bit to a low bit, or an order from the low bit to the high bit.

12. The computing apparatus of claim 1, wherein
the to-be-operated data is a vector, and performing the operation specified by the operation instruction comprises:
performing the operation between elements in the vector in parallel.

13-15. (canceled)

16. A method performed by a computing apparatus, comprising:
receiving a plurality of pieces of to-be-operated data associated with an operation instruction,
wherein at least one piece of to-be-operated data is represented by two or more components,
wherein the at least one piece of to-be-operated data has a source data bit width, and each of the components has a respective target data bit width, wherein the target data bit width is less than the source data bit width;
using the two or more components to replace the represented to-be-operated data to perform an operation specified by the operation instruction to obtain two or more intermediate results; and
combining the intermediate results to obtain a final result.

17. The method of claim 16, wherein
performing the operation specified by the operation instruction comprises:
using the two or more components of the one piece of to-be-operated data to perform the operation with corresponding data of other to-be-operated data respectively to obtain corresponding operation results; and
combining the intermediate results comprises:
performing weighted combining on the operation results to obtain the final result.

18. The method of claim 17, wherein the operation instruction comprises an instruction involving a multiplication operation or a multiplication and addition operation.

19. The method of claim 18, wherein each of the components has a component value and a component scale factor, and the component scale factor is associated with a bit position of a corresponding component in the represented to-be-operated data;
performing the operation specified by the operation instruction comprises:
using the component value to perform the operation to obtain the operation results; and
performing the weighted combining comprises:
using a weighting factor to perform weighted combining on a current operation result and a previous combination result, wherein the weighting factor is determined at least partly based on a component scale factor of a component corresponding to the operation result.

20. The method of claim 19, wherein performing the weighted combining comprises:
multiplying the operation result by a first weighting factor to obtain a weighted result, wherein the first weighting factor is a product of component scale factors of components corresponding to the operation result; and
accumulating the weighted result and the previous combination result.

21. The method of claim 19, wherein performing the weighted combining comprises:
multiplying the previous combination result by a second weighting factor to obtain a weighted result, wherein the second weighting factor is a ratio of a scale factor of a previous operation result to a scale factor of the current operation result, wherein the scale factor of the operation result is determined according to the component scale factor of the component corresponding to the operation result; and
accumulating the weighted result and the current operation result.

22. The method of claim 16, further comprising:
judging whether any one of data that is to be used to perform the operation is 0, wherein the data comprises any one of followings: original data of the to-be-operated data, or a component representing the to-be-operated data; and
not using the component to perform the operation specified by the operation instruction if the component is 0;
omitting performing the operation specified by the operation instruction on the data if the data is 0;
otherwise, using the data to perform the operation specified by the operation instruction.
